(19) United States
(12) Patent Application Publication
(10) Pub. No.: US 2021/0037506 A1
(43) Pub. Date: Feb. 4, 2021

(54) TERMINAL APPARATUS, BASE STATION APPARATUS, AND COMMUNICATION METHOD

(71) Applicants: Sharp Kabushiki Kaisha, Sakai City, Osaka (JP); FG Innovation Company Limited, New Territories (HK)

(72) Inventors: Tomoki YOSHIMURA, Sakai City (JP); Taewoo LEE, Sakai City (JP); Shoichi SUZUKI, Sakai City (JP); Wataru OUCHI, Sakai City (JP); Liqing LIU, Sakai City (JP); Daiichiro NAKASHIMA, Sakai City (JP)

(21) Appl. No.: 16/640,769

(22) PCT Filed: Jul. 31, 2018
(86) PCT No.: PCT/JP2018/028604

§ 371 Date: Feb. 21, 2020

(30) Foreign Application Priority Data
Sep. 7, 2017 (JP) 2017-172154

(51) Int. Cl. H04W 72/04

(52) U.S. Cl. CPC H04W 72/042

(57) ABSTRACT

Multiple PDCCH candidate groups included in a search space of a second aggregation level are given based on at least one or more PDCCH candidates included in a search space of a first aggregation level. Each of the multiple PDCCH candidate groups corresponds to each of the at least one or more PDCCH candidates included in the search space of the first aggregation level.

### TECHNICAL FIELD

The present invention relates to a terminal apparatus, a base station apparatus, and a communication method.

This application claims priority based on JP 2017-172154 filed on Sep. 7, 2017, the contents of which are incorporated herein by reference.

### BACKGROUND ART

In the 3rd Generation Partnership Project (3GPP), a radio access method and a radio network for cellular mobile communications (hereinafter referred to as “Long Term Evolution (LTE)” or “Evolved Universal Terrestrial Radio Access (EUTRA)”) have been studied. In LTE, a base station apparatus is also referred to as an evolved NodeB (eNodeB), and a terminal apparatus is also referred to as a User Equipment (UE). LTE is a cellular communication system in which multiple areas are deployed in a cellular structure, with each of the multiple areas being covered by a base station apparatus. A single base station apparatus may manage multiple serving cells.

In the 3GPP, for proposal to International Mobile Telecommunication (IMT)-2020, which is a standard for next-generation mobile communication system developed by the International Telecommunications Union (ITU), a next-generation standard (New Radio (NR)) has been studied (NPL 1). NR has been requested to meet requirements assuming three scenarios: enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology,” RP-160671, NTT docomo, 3GPP TSG RAN Meeting #71, Goteborg, Sweden, 7-10 Mar. 2016.

### SUMMARY OF INVENTION

### Technical Problem

One aspect of the present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention is a terminal apparatus including a receiver configured to monitor a PDCCH in a first search space of a first aggregation level and a second search space of a second aggregation level in a CORESET, wherein the first aggregation level is a maximum aggregation level among a set of aggregation levels configured for the CORESET, the second aggregation level is an aggregation level being included in the set and being lower than the first aggregation level, the first search space includes multiple first PDCCH candidates, the second search space includes multiple second PDCCH candidates, each of the multiple second PDCCH candidates is included in any one of multiple PDCCH candidate groups, each of the multiple first PDCCH candidates is mapped to multiple CCEs within the CORESET, the number of the multiple PDCCH candidate groups is the number of the multiple first PDCCH candidates, the number of the multiple second PDCCH candidates included in each of the multiple PDCCH candidate groups is given based on at least the number of the multiple first PDCCH candidates, and the number of the multiple second PDCCH candidates included in the second search space, each of the multiple PDCCH candidate groups corresponds to a different one of the multiple first PDCCH candidates, and a CCE constituting one of the multiple second PDCCH candidates included in the multiple PDCCH candidate groups is a part of multiple CCEs constituting the corresponding one of the multiple first PDCCH candidates.

(2) A second aspect of the present invention is a base station apparatus including a transmitter configured to transmit a PDCCH in a first search space of a first aggregation level and a second search space of a second aggregation level in a CORESET, wherein the first aggregation level is a maximum aggregation level among a set of aggregation levels configured for the CORESET, the second aggregation level is an aggregation level being included in the set and being lower than the first aggregation level, the first search space includes multiple first PDCCH candidates, the second search space includes multiple second PDCCH candidates, each of the multiple second PDCCH candidates is included in any one of multiple PDCCH candidate groups, each of the multiple first PDCCH candidates is mapped to multiple CCEs within the CORESET, the number of the multiple PDCCH candidate groups is the number of the multiple first PDCCH candidates, the number of the multiple second PDCCH candidates included in each of the multiple PDCCH candidate groups is given based on at least the number of the multiple first PDCCH candidates, and the number of the multiple second PDCCH candidates included in the second search space, each of the multiple PDCCH candidate groups corresponds to a different one of the multiple first PDCCH candidates, and a CCE constituting one of the multiple second PDCCH candidates included in the multiple PDCCH candidate groups is a part of multiple CCEs constituting the corresponding one of the multiple first PDCCH candidates.

(3) A third aspect of the present invention is a communication method used for a terminal apparatus, the communication method including the step of monitoring a PDCCH in a first search space of a first aggregation level and a second search space of a second aggregation level in a CORESET, wherein the first aggregation level is a maximum aggregation level among a set of aggregation levels configured for the CORESET, the second aggregation level is an aggregation level being included in the set and being lower than the first aggregation level, the first search space includes multiple first PDCCH candidates, the second search space includes multiple second PDCCH candidates, each of the multiple second PDCCH candidates is included in any one of multiple PDCCH candidate groups, each of the multiple first PDCCH candidates is mapped to multiple CCEs within the CORESET, the number of the multiple PDCCH candidate groups is the number of the multiple first PDCCH candidates, the number of the multiple second PDCCH candidates included in each of the multiple PDCCH candidate groups is given based on at least the number of the multiple first PDCCH candidates, and the number of the multiple second PDCCH candidates included in the second search space, each of the multiple PDCCH candidate groups corresponds to a different one of the multiple first PDCCH candidates, and a CCE constituting one of the multiple second PDCCH candidates included in the multiple PDCCH candidate groups is a part of multiple CCEs constituting the corresponding one of the multiple first PDCCH candidates.

(4) A fourth aspect of the present invention is a communication method used for a base station apparatus, the communication method including the step of transmitting a PDCCH in a first search space of a first aggregation level and a second search space of a second aggregation level in a CORESET, wherein the first aggregation level is a maximum aggregation level among a set of aggregation levels configured for the CORESET, the second aggregation level is an aggregation level being included in the set and being lower than the first aggregation level, the first search space includes multiple first PDCCH candidates, the second search space includes multiple second PDCCH candidates, each of the multiple second PDCCH candidates is included in any one of multiple PDCCH candidate groups, each of the multiple first PDCCH candidates is mapped to multiple CCEs within the CORESET, the number of the multiple PDCCH candidate groups is the number of the multiple first PDCCH candidates, the number of the multiple second PDCCH candidates included in each of the multiple PDCCH candidate groups is given based on at least the number of the multiple first PDCCH candidates, and the number of the multiple second PDCCH candidates included in the second search space, each of the multiple PDCCH candidate groups corresponds to a different one of the multiple first PDCCH candidates, and a CCE constituting one of the multiple second PDCCH candidates included in the multiple PDCCH candidate groups is a part of multiple CCEs constituting the corresponding one of the multiple first PDCCH candidates.

### Advantageous Effects of Invention

According to one aspect of the present invention, the terminal apparatus can efficiently perform communication. The base station apparatus can efficiently perform communication.

### BRIEF DESCRIPTION OF DRAWINGS

FIG. 1 is a conceptual diagram of a radio communication system according to one aspect of the present embodiment.

FIG. 2 is an example illustrating a relationship between N^{slot}_{symb}, a subcarrier spacing configuration μ, a slot configuration, and a CP configuration according to one aspect of the present embodiment.

FIG. 3 is a schematic diagram illustrating an example of a resource grid of a subframe according to one aspect of the present embodiment.

FIG. 4 is a diagram illustrating an example of first mapping of PDCCH candidates of aggregation levels X_{L}=8, 4, 2, and 1 according to one aspect of the present embodiment.

FIG. 5 is a diagram illustrating an example of second mapping of PDCCH candidates of aggregation levels X_{L}=8, 4, 2, and 1 according to one aspect of the present embodiment.

FIG. 6 is a diagram illustrating an example of third mapping of PDCCH candidates of aggregation levels X_{L}=8, 4, 2, and 1 according to one aspect of the present embodiment.

FIG. 7 is a diagram illustrating an example of fourth mapping of PDCCH candidates of aggregation levels X_{L}=8, 4, 2, and 1 according to one aspect of the present embodiment.

FIG. 8 is a schematic block diagram illustrating a configuration of a terminal apparatus 1 according to one aspect of the present embodiment.

FIG. 9 is a schematic block diagram illustrating a configuration of a base station apparatus 3 according to one aspect of the present embodiment.

### DESCRIPTION OF EMBODIMENTS

Embodiments of the present invention will be described below.

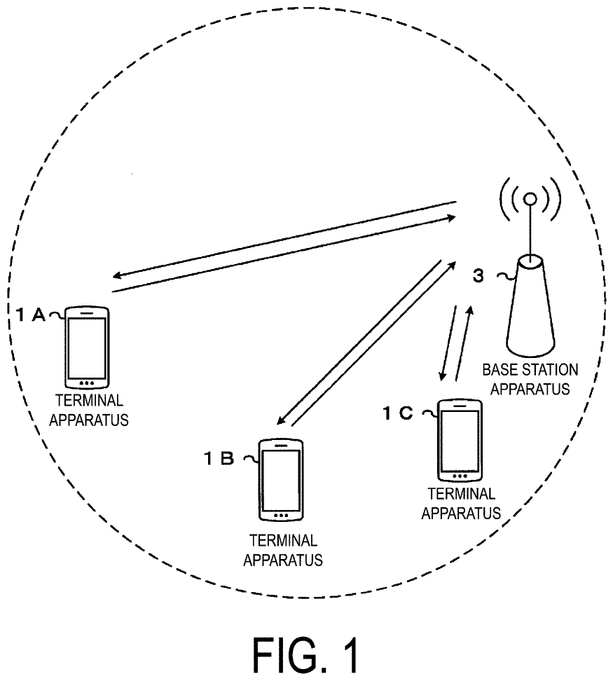

FIG. 1 is a conceptual diagram of a radio communication system according to one aspect of the present embodiment. In FIG. 1, a radio communication system includes terminal apparatuses 1A to 1C and a base station apparatus 3. Hereinafter, the terminal apparatuses 1A to 1C are also referred to as a terminal apparatus 1.

A frame configuration will be described below.

In the radio communication system according to one aspect of the present embodiment, at least Orthogonal Frequency Division Multiplex (OFDM) is used. An OFDM symbol, being a time domain unit of OFDM, includes at least one or more subcarriers, and is converted into a time-continuous signal (time-continuous signal) through baseband signal generation.

A SubCarrier Spacing (SCS) may be given by the equation: subcarrier spacing Δf=2 μ·15 kHz. For example, μ may be any of values 0 to 5. For a carrier band part (Carrier bandwidth part), μ used for subcarrier spacing configuration may be given by a higher layer parameter (subcarrier spacing configuration μ).

In the radio communication system according to one aspect of the present embodiment, a time unit Tₛ is used for representing a time domain length. The time unit Tₛ is given by the equation: Tₛ=1/(Δfₘₐₓ−N_{f}). Δfₘₐₓ may be a maximum value of the subcarrier spacing supported in the radio communication system according to one aspect of the present embodiment. Δfₘₐₓ may be Δfₘₐₓ=480 kHz. The time unit Tₛ is also referred to as Tₛ. A constant κ is κ=Δfₘₐₓ·N_{f}/(Δf_{ref}N_{f, ref})=64. Δf_{ref} is 15 kHz, and N_{f, ref} is 2048.

The constant κ may be a value indicating a relationship between a reference subcarrier spacing and Tₛ. The constant κ may be used for a subframe length. Based on at least the constant κ, the number of slots included in a subframe may be given. Δf_{ref} is a reference subcarrier spacing, and N_{f, ref} is a value corresponding to the reference subcarrier spacing.

Downlink transmission and/or uplink transmission is configured by a frame having a length of 10 ms. The frame includes 10 subframes. The subframe length is 1 ms. The frame length may be a value independent of the subcarrier spacing Δf. In other words, a frame configuration may be given regardless of μ. The subframe length may be a value independent of the subcarrier spacing Δf. In other words, a subframe configuration may be given regardless of μ.

For the subcarrier spacing configuration μ (subcarrier spacing configuration), the number and the index of the slots included in the subframe may be given. For example, a first slot number n^{μ}ₛ, may be given in the ascending order within a range from 0 to N^{subframe, μ}ₛₗₒₜ within the subframe. For the subcarrier spacing configuration μ, the number and the index of the slots included in the frame may be given. For example, a second slot number n^{μ}_{s, f} may be given in the ascending order within a range from 0 to N^{frame, μ}ₛₗₒₜ within the frame. N^{slot}_{symb} continuous OFDM symbols may be included in one slot. N^{slot}_{symb} may be given based on at least a part or all of a slot configuration and a Cyclic Prefix (CP) configuration. The slot configuration may be given by a higher layer parameter slot_configuration. The CP configuration may be given based on at least a higher layer parameter.

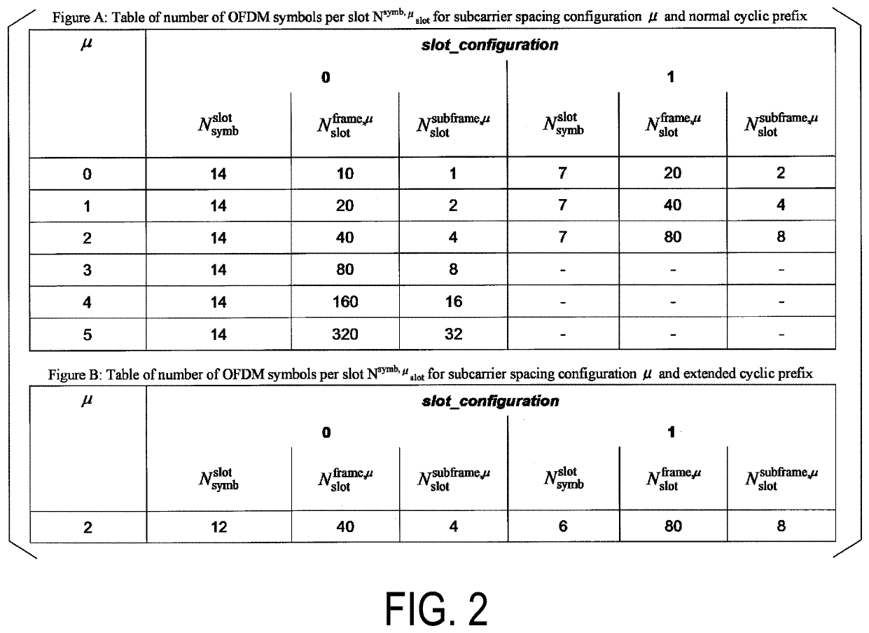

FIG. 2 is an example illustrating a relationship between N^{slot}_{symb}, the subcarrier spacing configuration μ, the slot configuration, and the CP configuration according to one aspect of the present embodiment. In FIG. 2A, in a case that the slot configuration is 0 and the CP configuration is a normal cyclic prefix (normal CP), N^{slot}_{symb}=14, N^{frame, μ}ₛₗₒₜ=40, and N^{subframe, μ}ₛₗₒₜ=4. In FIG. 2B, in a case that the slot configuration is 0 and the CP configuration is an extended cyclic prefix (extended CP), N^{slot}_{symb}=12, N^{frame, μ}ₛₗₒₜ=40, and N^{subframe, μ}ₛₗₒₜ=4. The value of N^{slot}_{symb} in slot configuration 0 may correspond to twice the value of N^{slot}_{symb} in slot configuration 1.

Physical resources will be described below.

An antenna port is defined based on that a channel on which symbols are transmitted in one antenna port can be estimated based on a channel on which other symbols are transmitted in the same antenna port. In a case that large scale property of a channel on which symbols are transmitted in one antenna port can be estimated based on a channel on which symbols are transmitted in another antenna port, the two antenna ports are referred to as being “Quasi Co-Located (QCL)”. The large scale property may be long distance property of a channel. The large scale property may include at least a part or all of delay spread, doppler spread, Doppler shift, an average gain, average delay, and beam parameters (spatial Rx parameters). A case that a first antenna port and a second antenna port are quasi co-located (QCL) with respect to the beam parameters may be equivalent to a case that a receive beam that a reception side assumes for the first antenna port and a receive beam that the reception side assumes for the second antenna port are the same. A case that the first antenna port and the second antenna port are quasi co-located (QCL) with respect to the beam parameters may be equivalent to a case that a transmit beam that a reception side assumes for the first antenna port and a transmit beam that the reception side assumes for the second antenna port are the same. In a case that the large scale property of a channel on which symbols are transmitted in one antenna port can be estimated based on a channel on which symbols are transmitted in another antenna port, the terminal apparatus 1 may assume that the two antenna ports are quasi co-located (QCL). A case that two antenna ports are quasi co-located (QCL) may be equivalent to a case that two antenna ports are assumed to be quasi co-located (QCL).

For each of the subcarrier spacing configuration and a set of carriers, a resource grid including N^{μ}_{RB, x}N^{RB}_{sc} subcarriers and N^{(μ)}_{symb}N^{subframe, μ}_{symb} OFDM symbols is given. N^{μ}_{RB, x} may indicate the number of resource blocks given for the subcarrier spacing configuration μ for carrier x. Carrier x indicates either a downlink carrier or an uplink carrier. In other words, x is either a “DL” or a “UL”. N^{μ}_{RB} is an expression encompassing N^{μ}_{RB, DL} and N^{μ}_{RB, UL}. N^{RB}_{sc} may indicate the number of subcarriers included in one resource block. One resource grid may be given for each antenna port p, and/or for each subcarrier spacing configuration μ, and/or for each transmission direction (Transmission direction) configuration. The transmission direction includes at least a DownLink (DL) and an UpLink (UL). A set of parameters including at least a part or all of the antenna port p, the subcarrier spacing configuration μ, and the transmission direction configuration is hereinafter also referred to as a first radio parameter set. In other words, one resource grid may be given for each first radio parameter set.

Each element of the resource grid given for each first radio parameter set is referred to as a resource element. The resource element is identified by a frequency domain index k and a time domain index 1. The resource element identified by the frequency domain index k and the time domain index 1 is also referred to as a resource element (k, 1). The frequency domain index k indicates any value from 0 to N^{μ}_{RB}N^{RB}_{sc}−1. N^{μ}_{RB} may be the number of resource blocks given for the subcarrier spacing configuration μ. N^{RB}_{sc} is the number of subcarriers included in the resource block, and N^{RB}_{sc}=12. The frequency domain index k may correspond to a subcarrier index. The time domain index 1 may correspond to an OFDM symbol index.

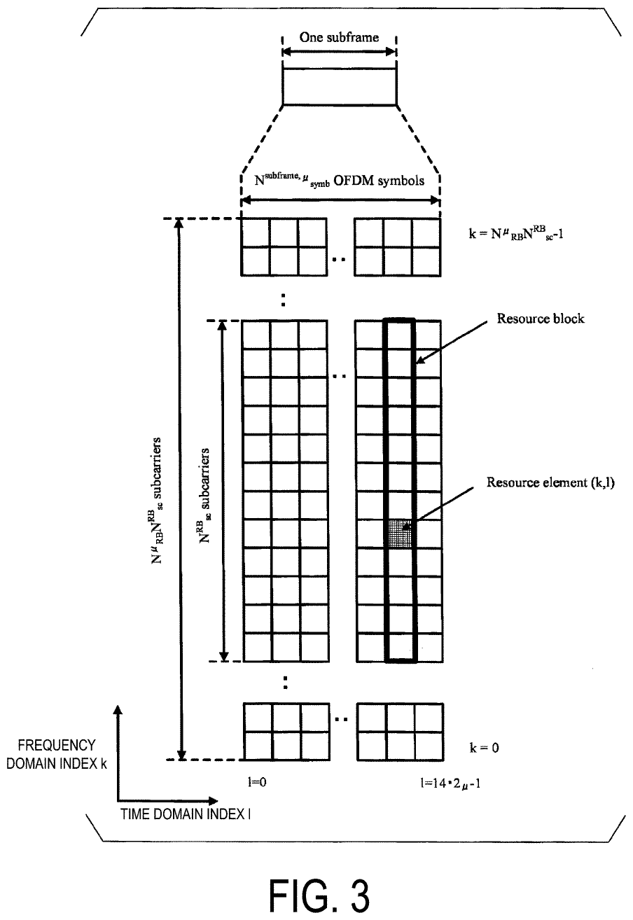

FIG. 3 is a schematic diagram illustrating an example of the resource grid of the subframe according to one aspect of the present embodiment. In the resource grid of FIG. 3, the horizontal axis represents the time domain index 1 and the vertical axis represents the frequency domain index k. In one subframe, the frequency domain of the resource grid may include N^{μ}_{RB}N^{RB}_{sc} subcarriers, and the time domain of the resource grid may include 14·2^{μ}−1 OFDM symbols. The resource block includes N^{RB}_{sc} subcarriers. The time domain of the resource block may correspond to one OFDM symbol. The time domain of the resource block may correspond to one or more slots. The time domain of the resource block may correspond to one subframe.

The terminal apparatus may receive indication to perform transmission and/or reception by using only a resource grid subset. The resource grid subset is also referred to as a carrier bandwidth part, and the carrier bandwidth part may be given by a higher layer parameter. In other words, the terminal apparatus need not receive indication to perform transmission and/or reception by using the whole resource grid set. In other words, the terminal apparatus may receive indication to perform transmission and/or reception by using a part of the resources in the resource grid.

The higher layer parameter is a parameter included in higher layer signaling. The higher layer signaling may be Radio Resource Control (RRC) signaling, or may be a Media Access Control Control Element (MAC CE). Here, the higher layer signaling may be RRC layer signaling, or may be MAC layer signaling.

Physical channels and physical signals according to various aspects of the present embodiment will be described below.

An uplink physical channel may correspond to a set of resource elements for carrying information generated in the higher layer. The uplink physical channel is a physical channel used in the uplink. In the radio communication system according to one aspect of the present embodiment, at least a part or all of the following uplink physical channels are used.
Physical Uplink Control CHannel (PUCCH)
Physical Uplink Shared CHannel (PUSCH)
Physical Random Access CHannel (PRACH)

The PUCCH may be used for transmitting Uplink Control Information (UCI). The uplink control information includes a part or all of Channel State Information (CSI) of a downlink physical channel, a Scheduling Request (SR), and a Hybrid Automatic Repeat request ACKnowledgement (HARQ-ACK) for downlink data (a Transport block (TB), a Medium Access Control Protocol Data Unit (MAC PDU), a Downlink-Shared Channel (DL-SCH), a Physical Downlink Shared Channel (PDSCH)). The HARQ-ACK may indicate an acknowledgement (ACK) or a negative-acknowledgement (NACK) for the downlink data.

The HARQ-ACK may indicate an ACK or a NACK corresponding to each of one or more Code Block Groups (CBGs) included in the downlink data. The HARQ-ACK is also referred to as a HARQ feedback, HARQ information, HARQ control information, and an ACK/NACK.

The scheduling request may be used at least for requesting PUSCH (Uplink-Shared Channel (UL-SCH)) resources for initial transmission.

The Channel State Information (CSI) includes at least a Channel Quality Indicator (CQI) and a Rank Indicator (RI). The channel quality indicator may include a Precoder Matrix Indicator (PMI). The CQI is an indicator associated with channel quality (propagation strength), and the PMI is an indicator for indicating a precoder. The RI is an indicator for indicating a transmission rank (or the number of transmission layers).

The PUSCH is used to transmit uplink data (TB, MAC PDU, UL-SCH, PUSCH). The PUSCH may be used to transmit HARQ-ACK and/or channel state information together with the uplink data. Furthermore, the PUSCH may be used to transmit only the channel state information or to transmit only the HARQ-ACK and the channel state information. The PUSCH is used to transmit random access message 3.

The PRACH is used to transmit a random access preamble (random access message 1). The PRACH is used for indicating initial connection establishment procedure, handover procedure, connection re-establishment procedure, synchronization (timing adjustment) for uplink data transmission, and a request for a PUSCH (UL-SCH) resource. The random access preamble may be used to notify the base station apparatus 3 of an index (random access preamble index) given by the higher layer of the terminal apparatus 1.

The random access preamble may be provided by cyclic-shifting of a Zadoff-Chu sequence corresponding to a physical root sequence index u. The Zadoff-Chu sequence may be generated based on the physical root sequence index u. Multiple random access preambles may be defined in one serving cell. The random access preamble may be identified based on at least the index of the random access preamble. Different random access preambles corresponding to different indices of random access preambles may correspond to different combinations of the physical root sequence index u and the cyclic shift. The physical root sequence index u and the cyclic shift may be provided based on at least information included in the system information. The physical root sequence index u may be an index for identifying a sequence included in the random access preamble. The random access preamble may be identified based on at least the physical root sequence index u.

In FIG. 1, the following uplink physical signals are used for the uplink radio communication. The uplink physical signal need not be used for transmitting information output from the higher layer, but is used by the physical layer.
UpLink Demodulation Reference Signal (UL DMRS)
Sounding Reference Signal (SRS)
UpLink Phase Tracking Reference Signal (UL PTRS)

The UL DMRS is associated with transmission of the PUSCH and/or the PUCCH. The UL DMRS is multiplexed on the PUSCH or the PUCCH. The base station apparatus 3 may use the UL DMRS in order to perform channel compensation of the PUSCH or the PUCCH. Simultaneous transmission of the PUSCH and the UL DMRS associated with the PUSCH is hereinafter simply referred to as transmission of the PUSCH. Simultaneous transmission of the PUCCH and the UL DMRS associated with the PUCCH is hereinafter simply referred to as transmission of the PUCCH. The UL DMRS associated with the PUSCH is also referred to as a PUSCH UL DMRS. The UL DMRS associated with the PUCCH is also referred to as a PUCCH UL DMRS.

The SRS need not be associated with transmission of the PUSCH or the PUCCH. The base station apparatus 3 may use the SRS to measure the channel state. The SRS may be transmitted at the end of the subframe in an uplink slot, or at an OFDM symbol preceding the end by a prescribed number of OFDM symbols.

The UL PTRS may be a reference signal used at least for phase tracking. The UL PTRS may be associated with a UL DMRS group including at least antenna port(s) used for one or more UL DMRSs. A case that the UL PTRS and the UL DMRS group are associated with each other may be equivalent to a case that the antenna port for the UL PTRS and a part or all of the antenna ports included in the UL DMRS group are at least quasi co-located (QCL). The UL DMRS group may be identified based on at least an antenna port having the smallest index in the UL DMRSs included in the UL DMRS group.

In FIG. 1, the following downlink physical channels are used for downlink radio communication from the base station apparatus 3 to the terminal apparatus 1. The downlink physical channels are used by the physical layer for transmission of information output from the higher layer.
Physical Broadcast Channel (PBCH)
Physical Downlink Control Channel (PDCCH)
Physical Downlink Shared Channel (PDSCH)

The PBCH is used to transmit a Master Information Block (a MIB, a BCH, a Broadcast Channel). The PBCH may be transmitted based on a prescribed transmission interval. For example, the PBCH may be transmitted at intervals of 80 ms. Contents of information included in the PBCH may be updated every 80 ms. The PBCH may include 288 subcarriers. The PBCH may include 2, 3, or 4 OFDM symbols. The MIB may include information relating to an identifier (index) of a synchronization signal. The MIB may include information for indicating at least a part of: the number of the slot in which PBCH is transmitted, the number of the subframe in which PBCH is transmitted, and the number of the radio frame in which PBCH is transmitted.

The PDCCH is used to transmit Downlink Control Information (DCI). The downlink control information is also referred to as a DCI format. The downlink control information may include at least either a downlink grant or an uplink grant. The downlink grant is also referred to as a downlink assignment or a downlink allocation.

A single downlink grant is used for at least scheduling of a single PDSCH in a single serving cell. The downlink grant is used at least for the scheduling of the PDSCH in the same slot as the slot in which the downlink grant is transmitted.

A single uplink grant is used at least for scheduling of a single PUSCH in a single serving cell.

One physical channel may be mapped to one serving cell. One physical channel need not be mapped to multiple serving cells.

To search for the PDCCH, one or more control resource sets are configured for the terminal apparatus 1. The terminal apparatus 1 attempts to receive the PDCCH in the configured control resource set(s).

The control resource set may indicate a time frequency domain in which one or more PDCCHs can be mapped. The control resource set may be a region in which the terminal apparatus 1 attempts to receive the PDCCH. The control resource set may include continuous resources (Localized resources). The control resource set may include non-continuous resources (distributed resources).

In the frequency domain, the unit of mapping the control resource set may be a resource block. In the time domain, the unit of mapping the control resource set may be the OFDM symbol.

The frequency domain of the control resource set may be identical to the system bandwidth of the serving cell. The frequency domain of the control resource set may be provided based on at least the system bandwidth of the serving cell. The frequency domain of the control resource set may be provided based on at least higher layer signaling and/or downlink control information.

The time domain of the control resource set may be provided based on at least a higher layer parameter.

The control resource set may include at least one or both of a Common control resource set and a Dedicated control resource set. The common control resource set may be a control resource set configured commonly to the multiple terminal apparatuses 1. The common control resource set may be given based on at least a part or all of MIBs, first system information, second system information, common RRC signaling, and a cell ID. The dedicated control resource set may be a control resource set configured to be dedicatedly used for the terminal apparatus 1. The dedicated control resource set may be given based on at least a part or all of dedicated RRC signaling and a value of a C-RNTI.

The common RRC signaling may be RRC signaling including a higher layer parameter mapped to a BCCH and/or a CCCH. The common RRC signaling may be RRC signaling given based on at least a part or all of MIBs, first system information, and second system information. The dedicated RRC signaling may be RRC signaling including a higher layer parameter mapped to a DCCH.

One or more search spaces may be configured for the control resource set. The one or more search spaces configured for the control resource set may be defined in advance. One or more search spaces configured for the common control resource set may be defined in advance. The one or more search spaces configured for the control resource set may be given based on at least a higher layer parameter. The one or more search spaces configured for the common control resource set may be given based on at least common RRC signaling. One or more search spaces configured for the dedicated control resource set may be given based on at least dedicated RRC signaling.

An Aggregation level (AL) may be given for each search space. One search space may correspond to one aggregation level. The aggregation level is a value indicating the number CCEs constituting PDCCH candidates that are included in the search space. In other words, a search space of aggregation level X may include one or more PDCCH candidates of aggregation level X.

The CCE is a physical resource allocation unit of the PDCCH candidate including six Resource Element Groups (REGs). The REG is defined as one OFDM symbol of one Physical Resource Block (PRB).

The number of PDCCH candidates may be given for each search space. The number of PDCCH candidates for each search space may be defined in advance. The number of PDCCH candidates for each search space may be given based on at least a higher layer parameter. The number of PDCCH candidates for each search space of the common control resource set may be given based on at least common RRC signaling. The number of PDCCH candidates for each search space of the common control resource set may be given based on at least dedicated RRC signaling. The number of PDCCH candidates of the dedicated control resource set may be given based on at least dedicated RRC signaling.

A set of aggregation levels of search spaces configured for the control resource set is also referred to as an aggregation level set. For example, a case that search spaces of aggregation levels X_{L}=8, 4, 2, and 1 are configured for the control resource set may be equivalent to a case that aggregation level set Φ_{X}={8, 4, 2, 1} is configured for the control resource set. A set including the number of PDCCH candidates of each of the search spaces configured for the control resource set is also referred to as a PDCCH candidate set. For example, a case that aggregation level set Φ_{X}={8, 4, 2, 1} is configured for the control resource set, the number of PDCCH candidates included in a search space of aggregation level X_{L}=8 is 2, the number of PDCCH candidates included in a search space of aggregation level X_{L}=4 is 2, the number of PDCCH candidates included in a search space of aggregation level X_{L}=2 is 6, and the number of PDCCH candidates included in a search space of aggregation level X_{L}=1 is 6 is also described as a case that PDCCH candidate set Φ_{N}={2, 2, 6, 6} is configured for the control resource set.

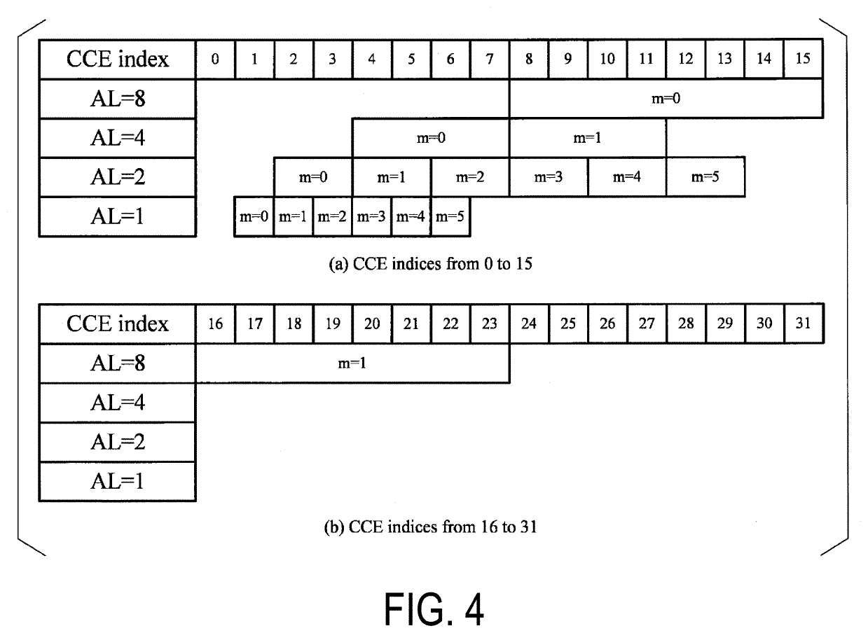

FIG. 4 is a diagram illustrating an example of first mapping of the PDCCH candidates of aggregation levels X_{L}=8, 4, 2, and 1 according to one aspect of the present embodiment. In FIG. 4, the number of CCEs included in the control resource set is configured to be 32, and each of the CCEs is assigned a number (CCE index) out of 0 to 31. FIG. 4(a) illustrates a range with the CCE indices from 0 to 15, and FIG. 4(b) illustrates a range with the CCE indices from 16 to 31. The CCE index is an index for identifying a CCE. The search space of each aggregation level includes PDCCH candidates including the number of CCEs corresponding to each aggregation level. In FIG. 4, the number N₈ of PDCCH candidates included in the search space of aggregation level X_{L}=8 is 2, and the two PDCCH candidates are identified by m=0 and m=1. L represents an aggregation level of a search space. A PDCCH candidate m is an index for identifying a PDCCH candidate of a prescribed aggregation level. In FIG. 4, the number N₄ of PDCCH candidates included in the search space of aggregation level X_{L}=4 is 2, and the two PDCCH candidates are identified by m=0 and m=1. In FIG. 4, the number N₂ of PDCCH candidates included in the search space of aggregation level X_{L}=2 is 6, and the six PDCCH candidates are identified by m=0, m=1, m=2, m=3, m=4, and m=5. In FIG. 4, the number N₁ of PDCCH candidates included in the search space of aggregation level X_{L}=1 is 6, and the six PDCCH candidates are identified by m=0, m=1, m=2, m=3, m=4, and m=5. The m-th PDCCH candidate among the PDCCH candidates included in a prescribed search space is also referred to as a PDCCH candidate m.

In other words, in FIG. 4, aggregation level set Φ_{X}={8, 4, 2, 1} and PDCCH candidate set Φ_{N}={2, 2, 6, 6} are configured for the control resource set.

As illustrated in FIG. 4, one PDCCH candidate may be mapped to continuous CCE indices. For example, PDCCH candidate m=0 of aggregation level X_{L}=8 is mapped to CCEs from CCE index 8 to CCE index 15. Further, as illustrated in FIG. 4, PDCCH candidates included in a search space of a certain aggregation level may be continuously mapped. A case that two or more PDCCH candidates are continuously mapped may indicate a case that CCE indices to which two or more PDCCH candidates are mapped are continuous.

According to the first scheme for the first mapping of the PDCCH candidates illustrated in FIG. 4, a CCE index S^{(L)}ₖ to which the PDCCH candidate is mapped may be given based on following Equation 1.

Sₖ^{(L)}=L{mod((Yₖ+m),floor(N_{CCE}/L)}+i Equation 1

Here, L may be an aggregation level of a search space. Yₖ may be a constant. Yₖ may be given based on at least a UE-specific value. Yₖ may be 0. m is an index of a PDCCH candidate included in a search space. N_{CCE} is the number of CCEs included in a control resource set. i may be i={0, . . . , L−1}. mod(A, B) indicates a remainder in a case that A is divided by B. floor(C) may indicate a maximum integer that does not exceed C. floor(C) may be a floor function.

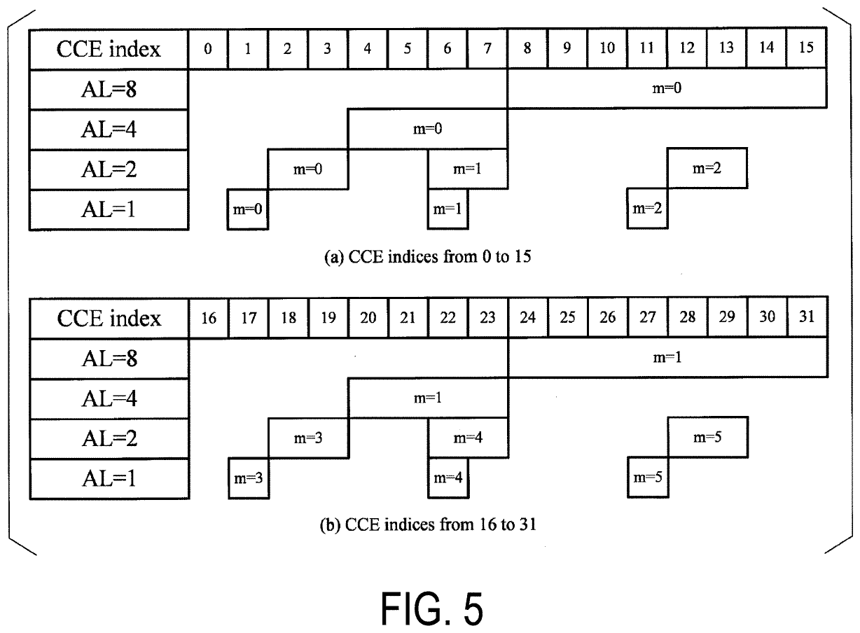

FIG. 5 is a diagram illustrating an example of second mapping of the PDCCH candidates of aggregation levels X_{L}=8, 4, 2, and 1 according to one aspect of the present embodiment. In FIG. 5, the number of CCEs included in the control resource set is configured to be 32, and each of the CCEs is assigned a number (CCE index) out of 0 to 31. FIG. 5(a) illustrates a range with the CCE indices from 0 to 15, and FIG. 5(b) illustrates a range with the CCE indices from 16 to 31. In FIG. 5, the number N₈ of PDCCH candidates included in the search space of aggregation level X_{L}=8 is 2, and the two PDCCH candidates are identified by m=0 and m=1. In FIG. 5, the number N₄ of PDCCH candidates included in the search space of aggregation level X_{L}=4 is 2, and the two PDCCH candidates are identified by m=0 and m=1. In FIG. 5, the number N₂ of PDCCH candidates included in the search space of aggregation level X_{L}=2 is 6, and the six PDCCH candidates are identified by m=0, m=1, m=2, m=3, m=4, and m=5. In FIG. 5, the number N₁ of PDCCH candidates included in the search space of aggregation level X_{L}=1 is 6, and the six PDCCH candidates are identified by m=0, m=1, m=2, m=3, m=4, and m=5.

In other words, in FIG. 5, aggregation level set Φ_{X}={8, 4, 2, 1} and PDCCH candidate set Φ_{N}={2, 2, 6, 6} are configured for the control resource set.

As illustrated in FIG. 5, the PDCCH candidates included in a search space of a certain aggregation level may be mapped in a distributed manner. A case that two PDCCH candidates are mapped in a distributed manner may represent a case that CCE indices to which two PDCCH candidates are mapped are distributed. A case that a first PDCCH candidate and a second PDCCH candidate are mapped in a distributed manner may be equivalent to a case that a minimum value of the CCE index to which the first PDCCH candidate is mapped and a maximum value of the CCE index to which the second PDCCH candidate is mapped are not continuous, and/or that a maximum value of the CCE index to which the first PDCCH candidate is mapped and a minimum value of the CCE index to which the second PDCCH candidate is mapped are not continuous.

From the perspective of the base station apparatus 3 that transmits the PDCCH, such a scheme that multiple PDCCH candidates of a certain aggregation level are mapped in a distributed manner is at least preferable in terms of performing frequency selection scheduling of the PDCCH.

According to the second scheme for the second mapping of the PDCCH candidates illustrated in FIG. 5, a CCE index S^{(L)}ₖ to which the PDCCH candidate is mapped may be given based on following Equation 2.

Sₖ^{(L)}=L{mod((Yₖ+floor(m*N_{CCE}/(L*N_{L}))+b),floor(N_{CCE}/L)}+i Equation 2

Here, N_{L} is the number of PDCCH candidates included in a search space of aggregation level X_{L}=L. b is a prescribed value. b may be given based on a serving cell index (for example, a carrier indicator) in carrier aggregation. b may be given based on a higher layer parameter. The carrier indicator may be indicated by a field included in DCI. The value of the carrier indicator may correspond to the serving cell index.

In the example illustrated in FIG. 5, at least one PDCCH is mapped to most of the CCE indices. The CCE indices to which the PDCCH candidate is not mapped in FIG. 5 are only CCE indices 0 and 16. In PDCCH candidate monitoring, the terminal apparatus 1 is requested to attempt channel estimation, channel compensation, and demodulation of physical resources corresponding to all the CCE indices except CCE index 0 and CCE index 16. This, however, means that a large attachment is applied to PDCCH candidate monitoring of the terminal apparatus 1. For example, such mapping that may enable preferable frequency selection scheduling and that may reduce an attachment applied to PDCCH candidate monitoring of the terminal apparatus 1 is desirable.

Third mapping for mapping of the PDCCH candidates will be described below.

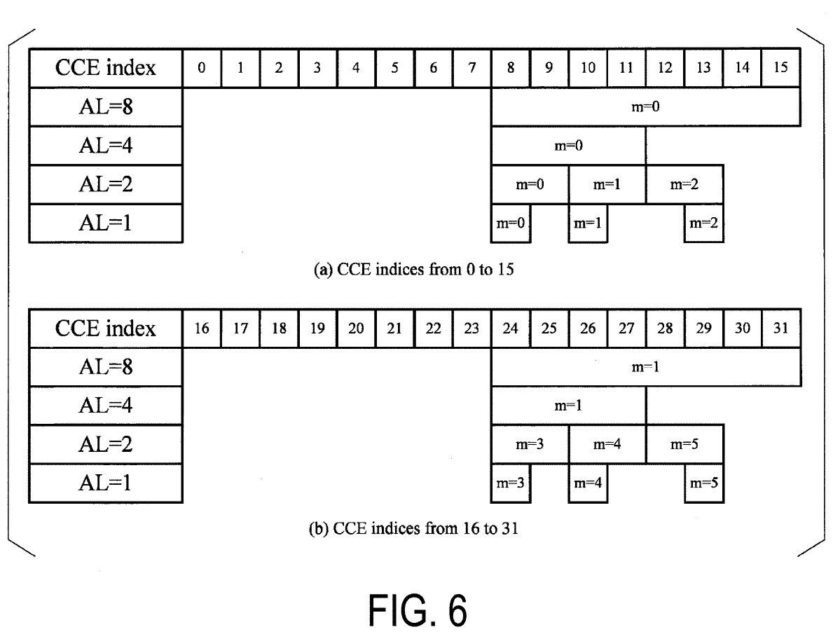

FIG. 6 is a diagram illustrating an example of third mapping of the PDCCH candidates of aggregation levels X_{L}=8, 4, 2, and 1 according to one aspect of the present embodiment. In FIG. 6, the number of CCEs included in the control resource set is configured to be 32, and each of the CCEs is assigned a number (CCE index) out of 0 to 31. FIG. 6(a) illustrates a range with the CCE indices from 0 to 15, and FIG. 6(b) illustrates a range with the CCE indices from 16 to 31. In FIG. 6, the number N₈ of PDCCH candidates included in the search space of aggregation level X_{L}=8 is 2, and the two PDCCH candidates are identified by m=0 and m=1. In FIG. 6, the number N₄ of PDCCH candidates included in the search space of aggregation level X_{L}=4 is 2, and the two PDCCH candidates are identified by m=0 and m=1. In FIG. 6, the number N₂ of PDCCH candidates included in the search space of aggregation level X_{L}=2 is 6, and the six PDCCH candidates are identified by m=0, m=1, m=2, m=3, m=4, and m=5. In FIG. 6, the number N₁ of PDCCH candidates included in the search space of aggregation level X_{L}=1 is 6, and the six PDCCH candidates are identified by m=0, m=1, m=2, m=3, m=4, and m=5.

In other words, in FIG. 6, aggregation level set Φ_{X}={8, 4, 2, 1} and PDCCH candidate set Φ_{N}={2, 2, 6, 6} are configured for the control resource set.

The third mapping of the PDCCH candidates illustrated in FIG. 6 indicates that the PDCCH candidates included in the search space of aggregation level X_{L}=8 are mapped in a distributed manner, and the PDCCH candidates included in the search spaces of aggregation levels X_{L}<8 are mapped within a range of the CCE indices to which the PDCCH candidates of the search space of aggregation level X_{L}=8 are mapped.

In the third mapping of the PDCCH candidates included in the search spaces configured for the control resource set, mapping of the PDCCH candidates included in a search space of the highest aggregation level X_{highest} in the aggregation level set Φ_{X} configured for the control resource set may be given based on at least the number N_{CCE} of CCEs included in the control resource set. The PDCCH candidates included in the search space of the highest aggregation level X_{highest} may be mapped to any CCE included in the control resource set. Mapping of the PDCCH candidates included in the search space of the highest aggregation level X_{highest} may be given based on the first mapping or the second mapping.

In the third mapping of the PDCCH candidates included in the search spaces configured for the control resource set, each of the PDCCH candidates included in the search spaces of the aggregation levels X_{lower} other than the highest aggregation level X_{highest} in the aggregation level set Φ_{X} configured for the control resource set may be included in any one of multiple PDCCH candidate groups (PDCCH groups). Here, the number of the multiple PDCCH candidate groups may be equal to the number N_{highest} of PDCCH candidates included in the search space of the aggregation level X_{highest}. A PDCCH candidate group index gᵢ may be a value within a range of gᵢ=0, N_{highest}−1. A PDCCH candidate group having the index gᵢ is also referred to as a PDCCH candidate group gᵢ. The number N_{g}, of one or more PDCCH candidates included in the PDCCH candidate group gᵢ may be given based on at least the number N_{highest} of PDCCH candidates included in the search space of the aggregation level X_{highest}, and the number N_{lower} of PDCCH candidates included in the search spaces of the aggregation levels X_{lower}. The number N_{g}, of PDCCH candidates included in the PDCCH candidate group gᵢ may be given based on at least ceil(N_{lower}/N_{highest}) and/or floor(N_{lower}/N_{highest}). ceil(D) may represent a minimum integer that does not fall below D. ceil(D) may be a ceiling function.

The PDCCH candidate(s) m included in the search space of the aggregation level X_{highest} may correspond to the PDCCH candidate group gᵢ. The PDCCH candidate(s) m included in the search space of the aggregation level X_{highest} may correspond to the PDCCH candidate group gᵢ on a one-to-one basis.

A case that the PDCCH candidate(s) m included in the search space of the aggregation level X_{highest} (PDCCH candidate m included in the search space of the aggregation level X_{highest}) corresponds to the PDCCH candidate group gᵢ may be equivalent to a case that the CCE index to which each of one or more PDCCH candidates m_{gi} included in the PDCCH candidate group gᵢ is mapped is included in the CCE index to which the PDCCH candidate(s) m is mapped. The PDCCH candidate m_{gi} is an index for identifying a PDCCH candidate included in the PDCCH candidate group gᵢ.

A case that the PDCCH candidate(s) m included in the search space of the aggregation level X_{highest} corresponds to the PDCCH candidate group gᵢ may be equivalent to a case that a minimum value of the CCE index to which the PDCCH candidate(s) m is mapped is equal to a minimum value of the CCE index to which at least one PDCCH candidate included in the PDCCH candidate group gᵢ is mapped.

Each of the PDCCH candidates m_{gi} may be mapped in a distributed manner to the CCE indices to which the PDCCH candidate(s) m are mapped.

The PDCCH candidates m may be mapped in a distributed manner in the control resource set.

The aggregation level X_{highest} may be given based on at least the aggregation level set Φ_{X} configured for the control resource set, and the PDCCH candidate set Φ_{N}. The aggregation level X_{highest} may be a maximum value out of the aggregation levels each having the number of corresponding PDCCH candidates being other than 0, among the aggregation levels included in the aggregation level set Φ_{X}. The value “other than 0” may be an integer of 1 or more. In other words, an actual aggregation level set Φ_{X, actual} may be given as a set of aggregation levels each having the number of PDCCH candidates being other than 0 and each included in the aggregation level set Φ_{X}. Further, the aggregation level X_{highest} may be a maximum value of the actual aggregation level set Φ_{X, actual}.

For example, in a case that aggregation level set Φ_{X}={8, 4, 2, 1} and PDCCH candidate set Φ_{N}={2, 2, 6, 6} are configured for the control resource set, the aggregation level X_{highest} may be 8. Here, the actual aggregation level set Φ_{X}, actual may be Φ_{X, actual}={8, 4, 2, 1}.

For example, in a case that aggregation level set (Φ_{X}={8, 4, 2, 1} and PDCCH candidate set Φ_{N}={0, 1, 6, 6} are configured for the control resource set, the aggregation level X_{highest} may be 4. Here, the actual aggregation level set Φ_{X, actual} may be Φ_{X, actual}={4, 2, 1}.

For example, in a case that aggregation level set (Φ_{X}={8, 4, 2, 1} and PDCCH candidate set Φ_{N}={0, 4, 6, 6} are configured for the control resource set, the aggregation level X_{highest,} may be 4. Here, the actual aggregation level set Φ_{X, actual} may be Φ_{X, actual}={4, 2, 1}.

According to the third scheme for the third mapping of the PDCCH candidates included in the search spaces configured for the control resource set, a CCE index S^{(L)}ₖ to which the PDCCH candidate is mapped may be given based on following Equation 3.

Sₖ^{(L)}=N_{off}+L{mod((Yₖ+floor(m*N_{CCE,max}/(L*N_{L}))+b),floor(N_{CCE,max}/L)}+i Equation 3

Here, N_{CCE, max} may be N_{CCE, highest}. N_{CCE, highest} may be the total number of CCEs to which the PDCCH candidates included in the search space of the aggregation level X_{highest} are mapped. For example, N_{CCE, highest} may be given by the equation: N_{CCE, highest}=X_{highest}×N_{highest}. N_{off} may be given based on following Equation 4.

N_{off}=mod(Yₖ*(ceil(N_{CCE}/N_{CCE,max})−1),N_{CCE}−N_{CCE,max}) Equation 4

In Equation (3), N_{CCE} of Equation (2) is replaced by N_{CCE, max}. N_{CCE, max} has a function of restricting a range of CCE indices to which the search space is mapped to a search space of the aggregation level X_{highest}. Further, N_{off} has a function of associating a minimum value of the CCE index to which PDCCH candidate m=0 of the search space of the aggregation level N_{lower} is mapped with the CCE index to which PDCCH candidate m=0 included in the search space of the aggregation level X_{highest} is mapped.

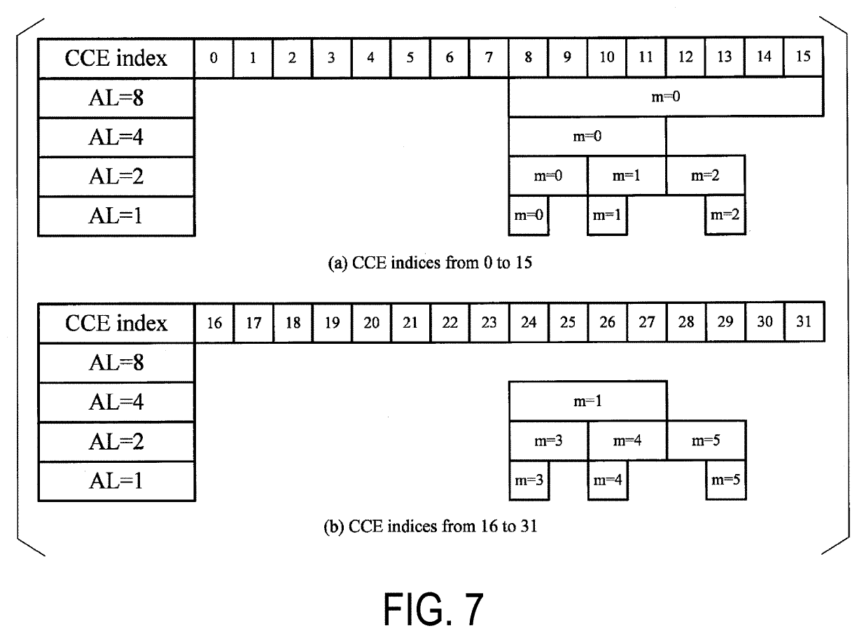

FIG. 7 is a diagram illustrating an example of fourth mapping of the PDCCH candidates of aggregation levels X_{L}=8, 4, 2, and 1 according to one aspect of the present embodiment. In FIG. 7, the number of CCEs included in the control resource set is configured to be 32, and each of the CCEs is assigned a number (CCE index) out of 0 to 31. FIG. 7(a) illustrates a range with the CCE indices from 0 to 15, and FIG. 7(b) illustrates a range with the CCE indices from 16 to 31. In FIG. 7, the number N₈ of PDCCH candidates included in the search space of aggregation level X_{L}=8 is 1, and the PDCCH candidate is identified by m=0. In FIG. 7, the number N₄ of PDCCH candidates included in the search space of aggregation level X_{L}=4 is 2, and the two PDCCH candidates are identified by m=0 and m=1. In FIG. 7, the number N₂ of PDCCH candidates included in the search space of aggregation level X_{L}=2 is 6, and the six PDCCH candidates are identified by m=0, m=1, m=2, m=3, m=4, and m=5. In FIG. 7, the number N₁ of PDCCH candidates included in the search space of aggregation level X_{L}=1 is 6, and the six PDCCH candidates are identified by m=0, m=1, m=2, m=3, m=4, and m=5.

In other words, in FIG. 7, aggregation level set Φ_{X}={8, 4, 2, 1} and PDCCH candidate set Φ_{N}={1, 2, 6, 6} are configured for the control resource set.

In the example illustrated in FIG. 7, the total number N_{CCE, highest} of CCEs to which the PDCCH candidates included in the search space of aggregation level X_{highest}=8 are mapped is smaller than the total number N_{CCE, 2} of CCEs to which the PDCCH candidates included in the search space of aggregation level X_{L}=2 are mapped. In a case of N_{CCE, highest}<N_{CCE, 2}, all the PDCCH candidates included in the search space of aggregation level X_{L}=2 cannot be mapped to a range of CCEs to which the PDCCH candidates included in the search space of aggregation level X_{highest}=8 are mapped.

In the fourth mapping of the PDCCH candidates included in the search space configured for the control resource set, mapping of the PDCCH candidates included in the search space of the highest aggregation level X_{highest} in the aggregation level set Φ_{X} configured for the control resource set may be given based on at least the number N_{CCE} of CCEs included in the control resource set. Mapping of the PDCCH candidates included in the search space of the highest aggregation level X_{highest} may be mapped to any CCE included in the control resource set.

In the fourth mapping of the PDCCH candidates included in the search space configured for the control resource set, each of the PDCCH candidates included in the search spaces of the aggregation levels X_{lower} other than the highest aggregation level X_{highest} in the aggregation level set Φ_{X} configured for the control resource set may be included in any one of multiple PDCCH candidate groups. Here, in a case that the total number N_{CCE, highest} of CCEs to which the PDCCH candidates included in the search space of the aggregation level X_{highest} are mapped is smaller than the total number N_{CCE, lower} of CCEs to which the PDCCH candidates included in the search spaces of the aggregation levels X_{lower} are mapped (in other words, in a case of N_{CCE, highest}<N_{CCE, lower}), the number of the multiple PDCCH candidate groups may be given based on at least N_{CCE, lower}. In the case of N_{CCE, highest}<N_{CCE, lower}, the number of the multiple PDCCH candidate groups may be given based on at least ceil(N_{CCE, lowe}r/X_{highest}). Further, in a case that the total number N_{CCE, highest} of CCEs to which the PDCCH candidates included in the search space of the aggregation level X_{highest} are mapped is equal to or larger than the total number N_{CCE, lower} of CCEs to which the PDCCH candidates included in the search spaces of the aggregation levels X_{lower} are mapped (in other words, in a case of N_{CCE, highest}>=N_{CCE, lower}), the number of the multiple PDCCH candidate groups may be equal to the number N_{highest} of PDCCH candidates included in the search space of the aggregation level X_{highest}. In other words, the number of the multiple PDCCH candidate groups may be given based on at least a value of N_{CCE, highest} and/or N_{CCE, lower}.

In the case of N_{CCE, highest}<N_{CCE, lower}, the number of the multiple PDCCH candidate groups may be given such that the product of the number of the multiple PDCCH candidate groups and the aggregation level X_{highest} is equal to or larger than N_{CCE, lower}.

The number of the PDCCH candidate groups may be given based on at least a value defined in advance and/or a higher layer parameter. In the case of N_{CCE, highest}<N_{CCE, lower}, the number of the PDCCH candidate groups may be given based on at least a value defined in advance and/or a higher layer parameter.

In a case that the aggregation level set Φ_{X} and the PDCCH candidate set Φ_{N} are configured for the control resource set, the number of the multiple PDCCH candidate groups may be given based on at least the total number N_{CCE, L} of CCEs to which the PDCCH candidates included in the search space of the aggregation level X_{L} are mapped. In a case that the total number N_{CCE, highest} of CCEs to which the PDCCH candidates included in the search space of the aggregation level X_{highest} are mapped is smaller than the maximum value N_{CCE, max} of N_{CCE, L} (in other words, in a case that N_{CCE, highest} is not equal to N_{CCE, max}), the number of the multiple PDCCH candidate groups may be given based on at least the aggregation level X_{highest}, and N_{CCE, max}. In a case that the total number N_{CCE, highest} of CCEs to which the PDCCH candidates included in the search space of the aggregation level X_{highest} are mapped is the maximum value N_{CCE, max} of N_{CCE, L}, the number of the multiple PDCCH candidate groups may be equal to N_{highest}.

In order that each of the PDCCH candidates included in the PDCCH candidate group gᵢ included in the search spaces of the aggregation levels X_{lower} be sufficiently distributed within the CCE indices to which the PDCCH candidate(s) m included in the search space of a corresponding aggregation level X_{highest} is mapped, the number of PDCCH candidates included in the PDCCH candidate group gi may be restricted. For example, a maximum number N_{gi, max} of the PDCCH candidates included in the PDCCH candidate group gi may be given based on at least a higher layer parameter and/or a value defined in advance.

In other words, the number of PDCCH candidates included in the PDCCH candidate group gi may be given based on at least min(ceil(N_{lower}/N_{highest}), N_{gi, max}) and/or min(floor(N_{lower}/N_{highest}), N_{gi, max}). Here, min(E, F) may be a function that outputs the smaller value of E and F.

Further, for example, the number Mower of PDCCH candidates included in the search spaces of the aggregation levels X_{lower} may be given based on at least a part or all of the aggregation level X_{highest}, the number N_{highest} of PDCCH candidates included in the search space of the aggregation level X_{highest}, and the aggregation levels X_{lower}.

In mapping of the PDCCH candidates included in the search space configured for the common control resource set, the first mapping or the second mapping may be at least used. In mapping of the PDCCH candidates included in the search space configured for the dedicated control resource set, the third mapping or the fourth mapping may be used.

In mapping of the PDCCH candidates included in a common search space configured for the control resource set, the first mapping or the second mapping may be at least used. In mapping of the PDCCH candidates included in a dedicated search space configured for the control resource set, the third mapping or the fourth mapping may be used.

Here, the common search space may include search space(s) of one or more aggregation levels. The common search space may be given based on at least a part or all of MIBs, first system information, second system information, common RRC signaling, and a cell ID. Further, the dedicated search space may include search space(s) of one or more aggregation levels. The dedicated search space may be given based on at least a part or all of dedicated RRC signaling and a value of a C-RNTI.

The PDSCH is used to transmit downlink data (DL-SCH, PDSCH). The PDSCH is used at least for transmitting random access message 2 (random access response). The PDSCH is used at least for transmitting system information including parameters used for initial access.

The PDSCH is given based on at least a part or all of Scrambling, Modulation, layer mapping, precoding, and Mapping to physical resources. The terminal apparatus 1 may assume that the PDSCH is given based on at least a part or all of scrambling, modulation, layer mapping, precoding, and mapping to physical resources.

In FIG. 1, the following downlink physical signals are used for the downlink radio communication. The downlink physical signal need not be used for transmitting the information output from the higher layer, but is used by the physical layer.
Synchronization signal (SS)
DownLink DeModulation Reference Signal (DL DMRS)
Shared Reference Signal (Shared RS)
Channel State Information-Reference Signal (CSI-RS)
DownLink Phase Tracking Reference Signal (DL PTRS)
Tracking Reference Signal (TRS)

The synchronization signal is used for the terminal apparatus 1 to establish synchronization in the frequency domain and/or the time domain in the downlink. The synchronization signal includes a Primary Synchronization Signal (PSS) and a Secondary Synchronization Signal (SSS).

An SS block includes at least a part or all of the PSS, the SSS, and the PBCH. The antenna port for each of a part or all of the PSS, the SSS, and the PBCH included in the SS block may be the same. A part or all of the PSS, the SSS, and the PBCH included in the SS block may be mapped to continuous OFDM symbols. The CP configuration of each of a part or all of the PSS, the SSS, and the PBCH included in the SS block may be the same. The subcarrier spacing configuration μ of each of a part or all of the PSS, the SSS, and the PBCH included in the SS block may be the same.

The DL DMRS is associated with transmission of the PBCH, the PDCCH, and/or the PDSCH. The DL DMRS is multiplexed on the PBCH, the PDCCH, or the PDSCH. In order to perform channel compensation of the PBCH, the PDCCH, or the PDSCH, the terminal apparatus 1 may use the DL DMRS that corresponds to the PBCH, the PDCCH, or the PDSCH. Transmission of the PBCH and the DL DMRS associated with the PBCH together is hereinafter briefly referred to as transmission of the PBCH. Transmission of the PDCCH and the DL DMRS associated with the PDCCH together is hereinafter simply referred to as transmission of the PDCCH. Transmission of the PDSCH and the DL DMRS associated with the PDSCH together is hereinafter simply referred to as transmission of the PDSCH. The DL DMRS associated with the PBCH is also referred to as a PBCH DL DMRS. The DL DMRS associated with the PDSCH is also referred to as a PDSCH DL DMRS. The DL DMRS associated with the PDCCH is also referred to as a DL DMRS associated with the PDCCH.

The Shared RS may be at least associated with transmission of the PDCCH. The Shared RS may be multiplexed on the PDCCH. The terminal apparatus 1 may use the Shared RS in order to perform channel compensation of the PDCCH. Transmission of the PDCCH and the Shared RS associated with the PDCCH together is hereinafter also simply referred to as transmission of the PDCCH.

The DL DMRS may be a reference signal configured for each individual terminal apparatus 1. A DL DMRS sequence may be given based on at least a parameter configured for each individual terminal apparatus 1. The DL DMRS sequence may be given based on at least a UE-specific value (for example, a C-RNTI or the like). The DL DMRS may be transmitted for each individual PDCCH and/or PDSCH. In contrast, the Shared RS may be a reference signal configured to be shared by multiple terminal apparatuses 1. A Shared RS sequence may be given regardless of a parameter configured for each individual terminal apparatus 1. For example, the Shared RS sequence may be given based on at least a part of a slot number, a mini-slot number, and a cell identity (ID). The Shared RS may be a reference signal to be transmitted, regardless of whether the PDCCH and/or the PDSCH is transmitted.

The CSI-RS may be a signal used at least for calculating channel state information. CSI-RS patterns assumed by the terminal apparatus may be given by at least a higher layer parameter.

The PTRS may be a signal used at least for phase noise compensation. PTRS patterns assumed by the terminal apparatus may be given based on at least a higher layer parameter and/or DCI.

The DL PTRS may be associated with a DL DMRS group including at least antenna port(s) used for one or more DL DMRSs. A case that the DL PTRS and the DL DMRS group are associated with each other may be equivalent to a case that the antenna port for the DL PTRS and a part or all of the antenna ports included in the DL DMRS group are at least quasi co-located (QCL). The DL DMRS group may be identified based on at least an antenna port having the smallest index in the DL DMRSs included in the DL DMRS group.

The TRS may be a signal used at least for time and/or frequency synchronization. TRS patterns assumed by the terminal apparatus may be given based on at least a higher layer parameter and/or DCI.

Each of the downlink physical channel and the downlink physical signal is also referred to as a downlink signal. Each of the uplink physical channel and the uplink physical signal is also referred to as an uplink signal. The downlink signal and the uplink signal are collectively also referred to as a signal. The downlink physical channel and the uplink physical channel are collectively referred to as a physical channel. The downlink physical signal and the uplink physical signal are collectively referred to as a physical signal.

The BCH, the UL-SCH, and the DL-SCH are transport channels. The channel used in the Medium Access Control (MAC) layer is referred to as a transport channel. The unit of transport channels used in the MAC layer is also referred to as a transport block (TB) or a MAC PDU. A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and modulation processing is performed for each codeword.

The base station apparatus 3 and the terminal apparatus 1 exchange (transmit and/or receive) a signal in the higher layer. For example, the base station apparatus 3 and the terminal apparatus 1 may transmit and/or receive Radio Resource Control (RRC) signaling (also referred to as a Radio Resource Control (RRC) message or Radio Resource Control (RRC) information) in a Radio Resource Control (RRC) layer. Furthermore, the base station apparatus 3 and the terminal apparatus 1 may transmit and/or receive a MAC Control Element (CE) in the MAC layer. Here, the RRC signaling and/or the MAC CE is also referred to as higher layer signaling.

The PUSCH and the PDSCH are used at least to transmit the RRC signaling and/or the MAC CE. Here, the RRC signaling transmitted from the base station apparatus 3 on the PDSCH may be signaling common to multiple terminal apparatuses 1 in a serving cell. The signaling common to multiple terminal apparatuses 1 in a serving cell is also referred to as common RRC signaling. The RRC signaling transmitted from the base station apparatus 3 on the PDSCH may be signaling dedicated to a certain terminal apparatus 1 (also referred to as dedicated signaling or UE specific signaling). The signaling dedicated to the terminal apparatus 1 is also referred to as dedicated RRC signaling. A higher layer parameter specific to a serving cell may be transmitted using signaling common to multiple terminal apparatuses 1 within the serving cell, or signaling dedicated to a certain terminal apparatus 1. A UE-specific higher layer parameter may be transmitted using signaling dedicated to a certain terminal apparatus 1. The PDSCH including the dedicated RRC signaling may be scheduled on the PDCCH in the first control resource set.

The Broadcast Control CHannel (BCCH), the Common Control CHannel (CCCH), and the Dedicated Control CHannel (DCCH) are logical channels. For example, the BCCH is a higher layer channel used to transmit the MIB. Moreover, the Common Control Channel (CCCH) is a higher layer channel used to transmit information common to multiple terminal apparatuses 1. Here, the CCCH is used for the terminal apparatus 1 which is not in an RRC-connected state, for example. Moreover, the Dedicated Control Channel (DCCH) is a higher layer channel used to transmit individual control information (dedicated control information) to the terminal apparatus 1. Here, the DCCH is used for the terminal apparatus 1 which is in an RRC-connected state, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel is mapped to the PUSCH in the physical channel. The DL-SCH in the transport channel is mapped to the PDSCH in the physical channel. The BCH in the transport channel is mapped to the PBCH in the physical channel.

A configuration example of the terminal apparatus 1 according to the one aspect of the present embodiment will be described below.

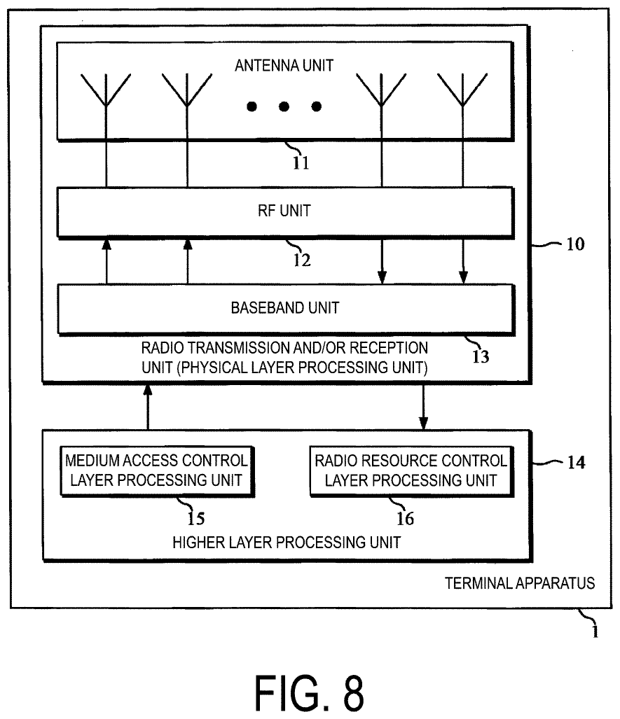

FIG. 8 is a schematic block diagram illustrating a configuration of the terminal apparatus 1 according to one aspect of the present embodiment. As illustrated, the terminal apparatus 1 includes a radio transmission and/or reception unit 10 and a higher layer processing unit 14. The radio transmission and/or reception unit 10 includes at least a part or all of an antenna unit 11, a Radio Frequency (RF) unit 12, and a baseband unit 13. The higher layer processing unit 14 includes at least a part or all of a medium access control layer processing unit 15 and a radio resource control layer processing unit 16. The radio transmission and/or reception unit 10 is also referred to as a transmitter, a receiver or a physical layer processing unit.

The higher layer processing unit 14 outputs uplink data (transport block) generated by a user operation or the like, to the radio transmission and/or reception unit 10. The higher layer processing unit 14 performs processing of a MAC layer, a Packet Data Convergence Protocol (PDCP) layer, a Radio Link Control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters, based on a higher layer signal received from the base station apparatus 3. Namely, the radio resource control layer processing unit 16 sets the various types of configuration information/parameters, based on the information for indicating the various types of configuration information/parameters received from the base station apparatus 3. Each of the parameters may be a higher layer parameter.

The radio transmission and/or reception unit 10 performs processing of the physical layer, such as modulation, demodulation, coding, decoding, and the like. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data and generating a baseband signal (performing conversion to a time-continuous signal), and transmits the generated signal to the base station apparatus 3.

The RF unit 12 converts (down-converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the digital signal resulting from the conversion, performs Fast Fourier Transform (FFT) of the signal from which the CP has been removed, and extracts a signal in the frequency domain.

The baseband unit 13 generates an OFDM symbol by performing Inverse Fast Fourier Transform (IFFT) of the data, adds CP to the generated OFDM symbol, generates a baseband digital signal, and converts the baseband digital signal into an analog signal. The baseband unit 13 outputs the analog signal resulting from the conversion, to the RF unit 12.

The RF unit 12 removes unnecessary frequency components from the analog signal input from the baseband unit 13 using a low-pass filter, up-converts the analog signal into a signal of a carrier frequency, and transmits the up-converted signal via the antenna unit 11. Furthermore, the RF unit 12 amplifies power. Furthermore, the RF unit 12 may have a function of controlling transmit power. The RF unit 12 is also referred to as a transmit power control unit.

A configuration example of the base station apparatus 3 according to one aspect of the present embodiment will be described below.

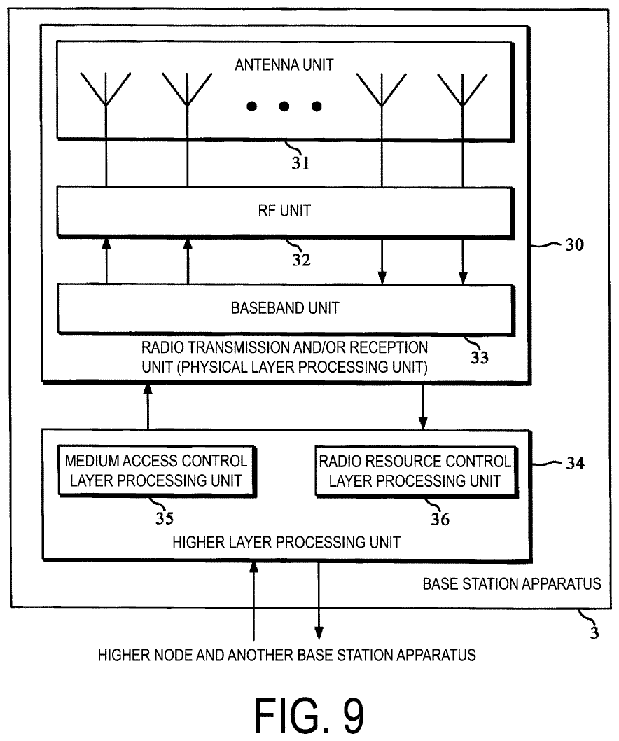

FIG. 9 is a schematic block diagram illustrating a configuration of the base station apparatus 3 according to one aspect of the present embodiment. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver or a physical layer processing unit.

The higher layer processing unit 34 performs processing of a MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) allocated on PDSCH, system information, an RRC message, a MAC CE, and the like, and performs output to the radio transmission and/or reception unit 30. Furthermore, the radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. That is, the radio resource control layer processing unit 36 transmits/broadcasts information for indicating various types of configuration information/parameters.

The functionality of the radio transmission and/or reception unit 30 is similar to the functionality of the radio transmission and/or reception unit 10, and hence description thereof is omitted.

Each of the units having the reference signs 10 to 16 included in the terminal apparatus 1 may be configured as a circuit. Each of the units having the reference signs 30 to 36 included in the base station apparatus 3 may be configured as a circuit.

Various aspects of apparatuses according to one aspect of the present embodiment will be described below.

(1) To accomplish the object described above, aspects of the present invention are contrived to provide the following measures. Specifically, a first aspect of the present invention is a terminal apparatus including a receiver configured to monitor a PDCCH in a first search space of a first aggregation level and a second search space of a second aggregation level in a CORESET, wherein the first aggregation level is a maximum aggregation level among a set of aggregation levels configured for the CORESET, the second aggregation level is an aggregation level being included in the set and being lower than the first aggregation level, the first search space includes multiple first PDCCH candidates, the second search space includes multiple second PDCCH candidates, each of the multiple second PDCCH candidates is included in any one of multiple PDCCH candidate groups, each of the multiple first PDCCH candidates is mapped to multiple CCEs within the CORESET, the number of the multiple PDCCH candidate groups is the number of the multiple first PDCCH candidates, the number of the multiple second PDCCH candidates included in each of the multiple PDCCH candidate groups is given based on at least the number of the multiple first PDCCH candidates, and the number of the multiple second PDCCH candidates included in the second search space, each of the multiple PDCCH candidate groups corresponds to a different one of the multiple first PDCCH candidates, and a CCE constituting one of the multiple second PDCCH candidates included in the multiple PDCCH candidate groups is a part of multiple CCEs constituting the corresponding one of the multiple first PDCCH candidates.

(2) In the first aspect of the present invention, each of the multiple second PDCCH candidates included in each of the multiple PDCCH candidate groups is distributedly mapped to the multiple CCEs constituting the corresponding one of the multiple first PDCCH candidates.

(3) In the first aspect of the present invention, each of the multiple first PDCCH candidates is distributedly mapped to multiple CCEs.

(4) A second aspect of the present invention is a base station apparatus including a transmitter configured to transmit a PDCCH in a first search space of a first aggregation level and a second search space of a second aggregation level in a CORESET, wherein the first aggregation level is a maximum aggregation level among a set of aggregation levels configured for the CORESET, the second aggregation level is an aggregation level being included in the set and being lower than the first aggregation level, the first search space includes multiple first PDCCH candidates, the second search space includes multiple second PDCCH candidates, each of the multiple second PDCCH candidates is included in any one of multiple PDCCH candidate groups, each of the multiple first PDCCH candidates is mapped to multiple CCEs within the CORESET, the number of the multiple PDCCH candidate groups is the number of the multiple first PDCCH candidates, the number of the multiple second PDCCH candidates included in each of the multiple PDCCH candidate groups is given based on at least the number of the multiple first PDCCH candidates, and the number of the multiple second PDCCH candidates included in the second search space, each of the multiple PDCCH candidate groups corresponds to a different one of the multiple first PDCCH candidates, and a CCE constituting one of the multiple second PDCCH candidates included in the multiple PDCCH candidate groups is a part of multiple CCEs constituting the corresponding one of the multiple first PDCCH candidates.

(5) In the second aspect of the present invention, each of the multiple second PDCCH candidates included in each of the multiple PDCCH candidate groups is distributedly mapped to the multiple CCEs constituting the corresponding one of the multiple first PDCCH candidates.

(6) In the second aspect of the present invention, each of the multiple first PDCCH candidates is distributedly mapped to multiple CCEs.

A program running on the base station apparatus 3 and the terminal apparatus 1 according to one aspect of the present invention may be a program that controls a Central Processing Unit (CPU) and the like (program that causes a computer to perform its functions), so that the program implements the functions of the above-described embodiment according to one aspect of the present invention. The information handled in these apparatuses is temporarily stored in a Random Access Memory (RAM) while being processed. Thereafter, the information is stored in various types of Read Only Memory (ROM) such as a Flash ROM and a Hard Disk Drive (HDD), and when necessary, is read by the CPU to be modified or rewritten.

Note that the terminal apparatus 1 and the base station apparatus 3 according to the above-described embodiment may be partially achieved by a computer. In that case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station apparatus 3 according to the above-described embodiment may be achieved as an aggregation (apparatus group) including multiple apparatuses. Each of the apparatuses constituting such an apparatus group may include some or all portions of each function or each functional block of the base station apparatus 3 according to the above-described embodiment. The apparatus group is required to have each general function or each functional block of the base station apparatus 3. Furthermore, the terminal apparatus 1 according to the above-described embodiment can also communicate with the base station apparatus as the aggregation.

Furthermore, the base station apparatus 3 according to the above-described embodiment may serve as an Evolved Universal Terrestrial Radio Access Network (EUTRAN). Furthermore, the base station apparatus 3 according to the above-described embodiment may have some or all portions of the functions of a node higher than an eNodeB.

Furthermore, some or all portions of each of the terminal apparatus 1 and the base station apparatus 3 according to the above-described embodiment may be typically achieved as an LSI which is an integrated circuit or may be achieved as a chip set. The functional blocks of each of the terminal apparatus 1 and the base station apparatus 3 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case where with advances in semiconductor technology, a circuit integration technology with which an LSI is replaced appears, it is also possible to use an integrated circuit based on the technology.

Furthermore, according to the above-described embodiment, the terminal apparatus has been described as an example of a communication apparatus, but the present invention is not limited to such a terminal apparatus, and is applicable to a terminal apparatus or a communication apparatus of a fixed-type or a stationary-type electronic apparatus installed indoors or outdoors, for example, such as an Audio-Video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
10, 30 Radio transmission and/or reception unit
11, 31 Antenna unit
12, 32 RF unit
13, 33 Baseband unit
14, 34 Higher layer processing unit
15, 35 Medium access control layer processing unit
16, 36 Radio resource control layer processing unit

1. A terminal apparatus comprising:
a receiver configured to monitor a PDCCH in a first search space of a first aggregation level and a second search space of a second aggregation level in a CORESET, wherein
the first aggregation level is a maximum aggregation level among a set of aggregation levels configured for the CORESET,
the second aggregation level is an aggregation level being included in the set and being lower than the first aggregation level,
the first search space includes multiple first PDCCH candidates,
the second search space includes multiple second PDCCH candidates,
each of the multiple second PDCCH candidates is included in any one of multiple PDCCH candidate groups,
each of the multiple first PDCCH candidates is mapped to multiple CCEs within the CORESET,
the number of the multiple PDCCH candidate groups is the number of the multiple first PDCCH candidates,
the number of the multiple second PDCCH candidates included in each of the multiple PDCCH candidate groups is given based on at least the number of the multiple first PDCCH candidates, and the number of the multiple second PDCCH candidates included in the second search space,
each of the multiple PDCCH candidate groups corresponds to a different one of the multiple first PDCCH candidates, and
a CCE constituting one of the multiple second PDCCH candidates included in the multiple PDCCH candidate groups is a part of multiple CCEs constituting the corresponding one of the multiple first PDCCH candidates.

2. The terminal apparatus according to claim 1, wherein
each of the multiple second PDCCH candidates included in each of the multiple PDCCH candidate groups is distributedly mapped to the multiple CCEs constituting the corresponding one of the multiple first PDCCH candidates.

3. The terminal apparatus according to claim 2, wherein
each of the multiple first PDCCH candidates is distributedly mapped to multiple CCEs.

4. A base station apparatus comprising:
a transmitter configured to transmit a PDCCH in a first search space of a first aggregation level and a second search space of a second aggregation level in a CORESET, wherein
the first aggregation level is a maximum aggregation level among a set of aggregation levels configured for the CORESET,
the second aggregation level is an aggregation level being included in the set and being lower than the first aggregation level,
the first search space includes multiple first PDCCH candidates,
the second search space includes multiple second PDCCH candidates,
each of the multiple second PDCCH candidates is included in any one of multiple PDCCH candidate groups,
each of the multiple first PDCCH candidates is mapped to multiple CCEs within the CORESET,
the number of the multiple PDCCH candidate groups is the number of the multiple first PDCCH candidates,
the number of the multiple second PDCCH candidates included in each of the multiple PDCCH candidate groups is given based on at least the number of the multiple first PDCCH candidates, and the number of the multiple second PDCCH candidates included in the second search space,
each of the multiple PDCCH candidate groups corresponds to a different one of the multiple first PDCCH candidates, and
a CCE constituting one of the multiple second PDCCH candidates included in the multiple PDCCH candidate groups is a part of multiple CCEs constituting the corresponding one of the multiple first PDCCH candidates.

5. The base station apparatus according to claim 4, wherein
each of the multiple second PDCCH candidates included in each of the multiple PDCCH candidate groups is distributedly mapped to the multiple CCEs constituting the corresponding one of the multiple first PDCCH candidates.

6. The base station apparatus according to claim 5, wherein
each of the multiple first PDCCH candidates is distributedly mapped to multiple CCEs.

7. A communication method used for a terminal apparatus, the communication method comprising the step of:
monitoring a PDCCH in a first search space of a first aggregation level and a second search space of a second aggregation level in a CORESET, wherein
the first aggregation level is a maximum aggregation level among a set of aggregation levels configured for the CORESET,
the second aggregation level is an aggregation level being included in the set and being lower than the first aggregation level,
the first search space includes multiple first PDCCH candidates,
the second search space includes multiple second PDCCH candidates,
each of the multiple second PDCCH candidates is included in any one of multiple PDCCH candidate groups,
each of the multiple first PDCCH candidates is mapped to multiple CCEs within the CORESET,
the number of the multiple PDCCH candidate groups is the number of the multiple first PDCCH candidates,
the number of the multiple second PDCCH candidates included in each of the multiple PDCCH candidate groups is given based on at least the number of the multiple first PDCCH candidates, and the number of the multiple second PDCCH candidates included in the second search space,
each of the multiple PDCCH candidate groups corresponds to a different one of the multiple first PDCCH candidates, and
a CCE constituting one of the multiple second PDCCH candidates included in the multiple PDCCH candidate groups is a part of multiple CCEs constituting the corresponding one of the multiple first PDCCH candidates.

8. A communication method used for a base station apparatus, the communication method comprising the step of:
transmitting a PDCCH in a first search space of a first aggregation level and a second search space of a second aggregation level in a CORESET, wherein
the first aggregation level is a maximum aggregation level among a set of aggregation levels configured for the CORESET,
the second aggregation level is an aggregation level being included in the set and being lower than the first aggregation level,
the first search space includes multiple first PDCCH candidates,
the second search space includes multiple second PDCCH candidates,
each of the multiple second PDCCH candidates is included in any one of multiple PDCCH candidate groups,
each of the multiple first PDCCH candidates is mapped to multiple CCEs within the CORESET,
the number of the multiple PDCCH candidate groups is the number of the multiple first PDCCH candidates,
the number of the multiple second PDCCH candidates included in each of the multiple PDCCH candidate groups is given based on at least the number of the multiple first PDCCH candidates, and the number of the multiple second PDCCH candidates included in the second search space,
each of the multiple PDCCH candidate groups corresponds to a different one of the multiple first PDCCH candidates, and
a CCE constituting one of the multiple second PDCCH candidates included in the multiple PDCCH candidate groups is a part of multiple CCEs constituting the corresponding one of the multiple first PDCCH candidates.
